(19) United States
(12) Patent Application Publication
(10) Pub. No.: US 2023/0116751 A1
(43) Pub. Date: Apr. 13, 2023

(54) CERTIFICATE ENROLLMENT PROTOCOL FOR AN UNTRUSTWORTHY ELECTRONIC DEVICE

(71) Applicant: ARRIS Enterprises LLC., Suwanee, GA (US)

(72) Inventor: Cheng-Ming Chien, Taoyuan City (TW)

(73) Assignee: ARRIS Enterprises LLC, Suwanee, GA (US)

(21) Appl. No.: 17/960,382

(22) Filed: Oct. 5, 2022

Related U.S. Application Data
(60) Provisional application No. 63/253,703, filed on Oct. 8, 2021.

(51) Int. Cl. H04L 9/32

(52) U.S. Cl. CPC H04L 9/3268; H04L 9/3213; H04L 9/3297

(57) ABSTRACT

During operation, a computer system provides, addressed to an authorization server, a client identifier of a client in a network. Then, the computer system receives, associated with the authorization server, a device code associated with the client, a user code and a verification location. Moreover, the computer system provides, addressed to an electronic device, the user code and the verification location. Next, the computer system provides, addressed to the authorization server, a request for an access token, where the request includes the client identifier and the device code, and the computer system receives, associated with the authorization server, the access token. Furthermore, the computer system generates a certificate signing request (CSR), and provides, addressed to a certificate authority (CA), the CSR and the access token. Additionally, the computer system receives, associated with the CA, a signed CSR that is a valid digital certificate for the client.

### CROSS REFERENCE TO RELATED APPLICATIONS

This application claims priority under 35 U.S.C. 119(e) to U.S. Provisional Application Serial Number 63/253,703, “Certificate Enrollment Protocol for an Untrustworthy Electronic device,” filed on Oct. 8, 2021, by Cheng-Ming Chien, the contents of which are herein incorporated by reference.

### FIELD

The described embodiments relate to techniques for issuing or enrolling a certificate for an untrustworthy electronic device.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

In many networks, secure communication is used to prevent unauthorized monitoring or misuse of information. For example, Transport Layer Security or TLS (which was previously referred to as ‘Secure Sockets Layer’) encrypts data (such as passwords, credit card numbers or personal correspondence) sent over a network (such as the Internet) to ensure that eavesdroppers and hackers are unable to view the transmitted data. During a TLS session, the identity of a resource computer (such as a server) is verified, and encrypted communication (e.g., using public-private key encryption) is established between the resource computer and a second computer (or client) on the network. Notably, the identity of the resource computer may be established using a digital certificate, which the client can check to confirm that the digital certificate is valid and signed by a trusted entity (thereby confirming that the resource computer is trustworthy).

However, not all software or electronic devices are bound to a valid digital certificate before they are sold. It is typically difficult to issue a digital certificate to untrustworthy software or an untrustworthy electronic device.

In principle, this problem can be addressed using, e.g., a Simple Certificate Enrollment Protocol or SCEP (from Cisco Systems, Inc. of San Jose, California) to issue digital certificates. In practice, if a client is untrustworthy, then the client may need to provide a shared password in a certificate signing request (CSR) for validation by a certificate authority (CA) or SCEP server that issues digital certificates. However, if the password is disclosed, this causes another vulnerability. Moreover, maintenance of the relationship among a user, the password and the software or the electronic device should not be the responsibility of CA or SCEP server. Furthermore, if a one-time password is used, it is typically difficult to scale the issuing of digital certificates to a large number of users or clients.

Alternatively, an OAuth 2.0 Device Authorization Grant (from the Internet Engineering Task Force of Fremont, California) is another way to make software or an electronic device trustworthy via user authorization. Notably, the software or electronic device may use the OAuth 2.0 Device Authorization Grant protocol to obtain an access token, which can then be used to access any other system that trusts the access token. Typically, for security reasons, the access token has a short expiration time. Consequently, a client usually has to periodically refresh the access token. However, a resource computer often must verify, on a per-request basis, an access token using an authorization server. Because the authorization server usually performs verification for all requests from a client to a resource server, the authorization server may be a bottleneck in a large-scale deployment or ecosystem.

### SUMMARY

A computer system (e.g., which may be in or associated with a data center) that verifies a client in a network or software associated with the client is described. This computer system includes an interface circuit that communicates with an electronic device, an authorization server (e.g., an authorization server in a second computer system) and a CA (e.g., a CA in the second computer system or separate from the second computer system). During operation, the computer system provides, addressed to the authorization server, a client identifier (such as a serial number, an Internet Protocol address, a media access control or MAC address, etc.) associated with the client or the software. Then, the computer system receives, associated with the authorization server, a device code (such as a random or a pseudorandom number, an alphanumeric number, which may be associated with the client), a user code and a verification location. Moreover, the computer system provides, addressed to the electronic device, the user code (such as a user code of an administrator or an operator of the network or an administrator account for the network) and the verification location. Next, the computer system provides, addressed to the authorization server, a request for an access token, where the request includes the client identifier and the device code, and the computer system receives, associated with the authorization server, the access token (such as a random or a pseudorandom number, an alphanumeric code, etc.). Furthermore, the computer system generates a CSR, and provides, addressed to the CA, the CSR and the access token. Additionally, the computer system receives, associated with the CA, a signed CSR that is a valid digital certificate for the client or the software.

Moreover, the verification location may include a uniform resource identifier (URI), a uniform resource locator (URL) or an image that includes the verification location (such as a Quick Response or QR code).

Furthermore, the request may include a polling request for the access token.

Additionally, the access token may have an associated expiration time.

Note that the electronic device may be the access point. In some embodiments, the client communicates (e.g., the client identifier) with the access point using wireless communication. For example, the wireless communication may be compatible with an IEEE 802.11 communication protocol. Moreover, the client may include a second electronic device. In some embodiments, the client is included in the computer system (such as an Internet-of-things or IoT device) and the client may perform at least some of the aforementioned operations.

Another embodiment provides the authorization server, which performs counterpart operations to those performed by the computer system in one or more of the preceding embodiments and/or additional operations. Notably, the authorization server may: receive, associated with the computer system, the client identifier; provides, addressed to the computer system, the device code, the user code and the verification location; receives approval of an authorization request associated with the client identifier, where the approval is received from the administrator of the operator of the network or from the electronic device when the electronic device is an access point; receives, associated with the computer system, the request for the access token, where the request includes the client identifier and the device code; provides, addressed to the computer system, the access token; confirms, for the CA, that the access token is valid; and provide, addressed to the CA, the client identifier.

Another embodiment provides the CA, which performs counterpart operations to those performed by the computer system in one or more of the preceding embodiments and/or additional operations. Notably, the CA may: receive, associated with the computer system, the CSR and the access token; checks, with the authorization server, that the access token is valid; receives, associated with the authorization server, the client identifier; confirms that the client identifier matches corresponding information associated with the CSR; and provides, addressed to the computer system, the signed CSR that is the valid digital certificate for the client or the software.

Another embodiment provides the electronic device, which performs counterpart operations to those performed by the computer system in one or more of the preceding embodiments and/or additional operations. Notably, the electronic device may: receive, associated with the computer system, the user code and the verification location; provide or present the user code and the verification location; receive approval of the authorization request associated with the client identifier from the administrator or the operator; and provide, addressed to the authorization server, the approval. Alternatively, when the electronic device is the access point, the electronic device may: receive, associated with the computer system, the user code and the verification location; and provide, addressed to the authorization server, the approval, where the approval includes the user code, the verification and a certificate associated with the access point.

Another embodiment provides a computer-readable storage medium with program instructions for use with the computer system, the authorization server, the CA or the electronic device. When executed by the computer system, the authorization server, the CA or the electronic device, the program instructions cause the computer system, the authorization server, the CA or the electronic device to perform at least some of the aforementioned operations in one or more of the preceding embodiments, counterpart operations in one or more of the preceding embodiments and/or additional operations.

Another embodiment provides a method, which may be performed by the computer system, the authorization server, the CA or the electronic device. This method includes at least some of the aforementioned operations in one or more of the preceding embodiments, counterpart operations in one or more of the preceding embodiments and/or additional operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for verifying a client in a network or software associated with the client using a computer system in FIG. 1 in accordance with an embodiment of the present disclosure.

FIG. 3 is a flow diagram illustrating an example of a method for verifying a client in a network or software associated with the client using an authorization server in FIG. 1 in accordance with an embodiment of the present disclosure.

FIG. 4 is a flow diagram illustrating an example of a method for verifying a client in a network or software associated with the client using a certificate authority (CA) in FIG. 1 in accordance with an embodiment of the present disclosure.

FIG. 5 is a flow diagram illustrating an example of a method for verifying a client in a network or software associated with the client using an electronic device in FIG. 1 in accordance with an embodiment of the present disclosure.

FIG. 6 is a drawing illustrating an example of communication among an electronic device, a computer system, an authorization server and a CA in FIG. 1 in accordance with an embodiment of the present disclosure.

FIG. 7 is a drawing illustrating an example of communication among an access point, a computer system, an authorization server and a CA in FIG. 1 in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (e.g., which may be in or associated with a data center) that verifies a client in a network or software associated with the client is described. During operation, the computer system may provide, addressed to an authorization server, a client identifier. Then, the computer system may receive, associated with the authorization server, a device code, a user code and a verification location (e.g., a URI, a URL, a QR code, etc.). Moreover, the computer system may provide, addressed to an electronic device (which may be the client or an access point), the user code and the verification location. Next, the computer system may provide, addressed to the authorization server, a request for an access token, where the request includes the client identifier and the device code, and the computer system may receive, associated with the authorization server, the access token. Furthermore, the computer system may generate a CSR, and may provide, addressed to a CA, the CSR and the access token. Additionally, the computer system may receive, associated with the CA, a signed CSR that is a valid digital certificate for the client or the software.

By verify the client or the software, the validation techniques may allow the valid digital certificate to be issued to an initially untrustworthy client or untrustworthy software. Notably, by leveraging the access token (e.g., from an OAuth 2.0 Device Authorization Grant), the validation techniques may allow a certificate enrollment protocol (such as SCEP) to be used without requiring a shared password in the CSR for validation by the CA or that an SCEP server issue digital certificates. Moreover, by eliminating the need for the authorization server to subsequently verify all requests from the client, the validation techniques may remove a bottleneck during the verification. Consequently, the validation techniques may be scaled to a large number of users or clients in, e.g., a large-scale deployment or ecosystem. In some embodiments, the validation techniques may be automated (e.g., an administrator or an operator of a network may not need to approve an authorization request associated with the client identifier). Therefore, the validation techniques may increase the satisfaction of users of the network and/or the computer system, such as operators or administrators and/or customers.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

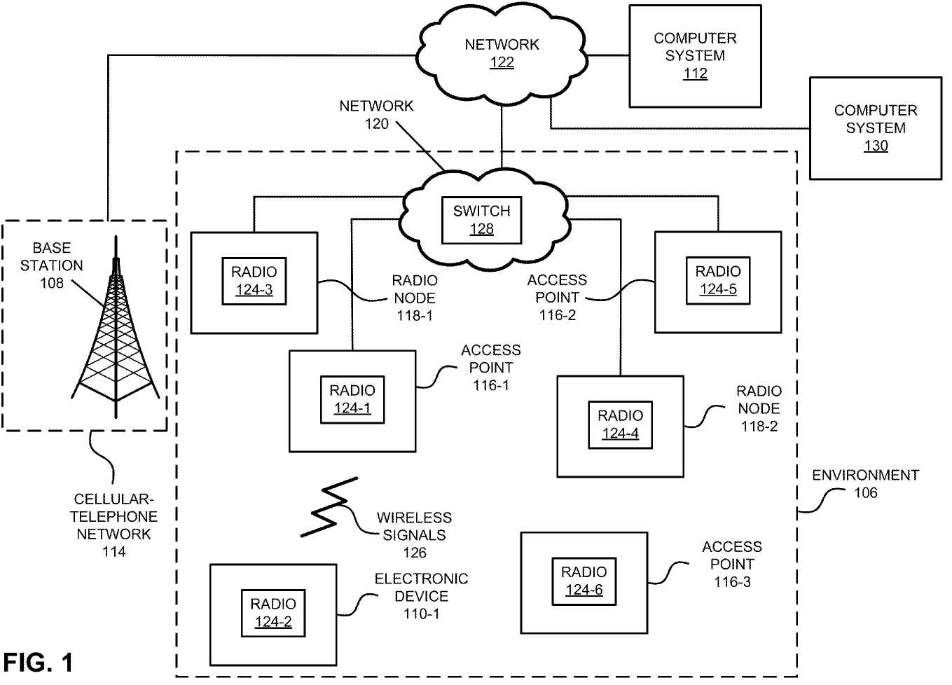

We now describe some embodiments of the verification techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, computer system 112 (which may be a local or a cloud-based controller that manages and/or configures access points 116, radio nodes 118 and/or switch 128, that provides cloud-based storage and/or analytical services, or which may be in or associated with a data center) and/or computer system 130 (which may include an authorization server and/or a CA) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

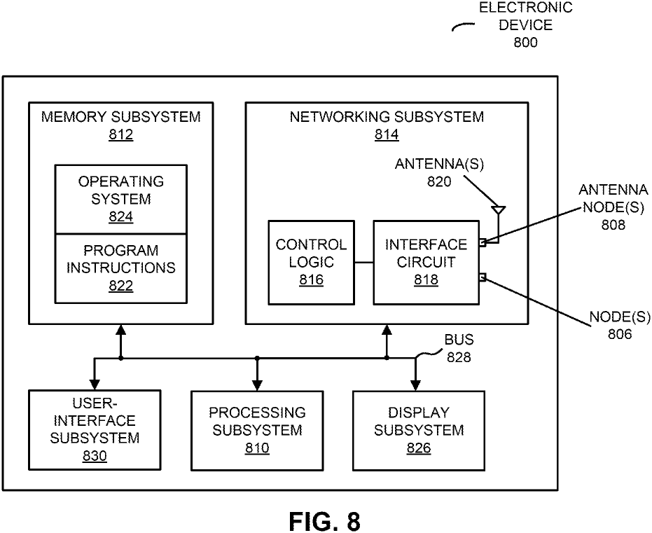

As described further below with reference to FIG. 8, electronic devices 110, computer system 112, access points 116, radio nodes 118, switch 128 and computer system 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

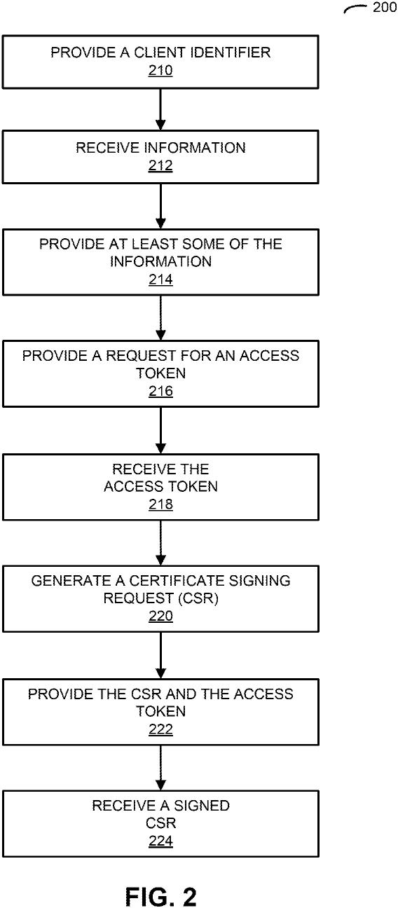

As discussed previously, it can be difficult to issue a valid digital certificate for an untrustworthy client (such as electronic device 110-1) or software (such as a virtual machine) associated with the untrustworthy client. Moreover, as described further below with reference to FIGS. 2-7, in order to addresses these problems, the verification techniques may be performed by computer system 112, computer system 130 (e.g., which may include the authorization server and/or the CA) and electronic device 110-2 or computer system 112, computer system 130, and one of access points 116 (such as access point 116-1) or one of radio nodes 118 (such as radio node 118-1). Note that electronic device 110-2 or access point 116-1 (or radio node 118-1) may, directly or indirectly, selectively approve an authorization request.

Notably, because a client or software associated with the client (such as software that is executed in an environment of the client, e.g., a virtual machine) is initially untrustworthy, the verification techniques may be used to assign or issue a digital certificate to a client in a network based at least in part on a client identifier (such as: a serial number, an Internet Protocol address, a MAC address, etc. of the client). The client (such as electronic device 110-1) may provide, e.g., via access point 116-1 (or radio node 118-1), the client identifier to computer system 112. Note that receive of the client identifier by computer system 112 may, directly or indirectly, indicate that the client needs a digital certificate. For example, the client may provide the client identifier along with a request for a valid digital certificate.

In response to receiving the client identifier, computer system 112 may provide, to computer system 130 (such as an authorization server in computer system 130), the client identifier. After receiving the client identifier, the authorization server may provide, to computer system 112, a device code (e.g., information associated with the client, such as a random number, a pseudorandom number or an alphanumeric number, which is paired with the client identifier), a user code (such as a user code of an administrator or an operator of the network or an administrator account for the network) and a verification location (such as a URI, a URL or a QR code where information specifying the authorization request can be access and selectively approved). Then, computer system 112 may receive, from the authorization server, the device code, the user code and the verification location.

Moreover, computer system 112 may provide, to the electronic device, the user code and the verification location. For example, the electronic device may be electronic device 110-2. Alternatively, the electronic device may be access point 116-1 (or radio node 118-1).

In embodiments where the electronic device is electronic device 110-2, after receiving the user code and the verification location from computer system 112, electronic device 110-2 may provide or present the user code and the verification location, e.g., via a user agent executing on or in an environment of electronic device 110-2 (such as in a browser or a plugin). Alternatively, the user code and the verification location may be pulled by the user agent from electronic device 110-2.

The administrator or the operator may use the user agent on electronic device 110-2 to review and selectively approve the authorization request associated with the client identifier. For example, a device list may be imported into the user agent, so the administrator or the operator can review and selectively approve the authorization request from or associated with the client. This selective approval may be received by the authorization server from electronic device 110-2. Alternatively or additionally, the administrator or the operator may login to the authorization server, and then may provide the user code and the verification location (from the user agent on electronic device 110-2) to the authorization server. In response, the authorization server may provide or present (e.g., on a display) the client identifier and/or associated an authorization request to the administrator or the operator for review and approval. Then, the authorization server may selectively receive approval of the authorization request associated with the client identifier from the administrator or the operator.

However, in embodiments a fully automated procedure may be used. Notably, the electronic device may be access point 116-1 (or radio node 118-1). This access point (or radio node) may have received the client identifier from electronic device 110-1 using wireless communication (such as wireless communication may be compatible with an IEEE 802.11 communication protocol), and may have provided the client identifier to computer system 112, thereby initiating the verification techniques. As described further below, the relatively short-range wireless communication between access point 116-1 (or radio node 118-1) and electronic device 110-1 may make it unlikely for a malicious party to compromise the verification techniques and the physical environment at the same time. Consequently, access point 116-1 (or radio node 118-1) may have an implicit trust relationship with electronic device 110-1. In these embodiments, access point 116-1 (or radio node 118-1) may provide, to the authorization server, the approval, where the approval includes information (such as the user code and the verification location) and a certificate associated with access point 116-1 (or radio node 118-1), such as a manufacturer certificate. Note that the selective approval may be received by the authorization server.

Next, computer system 112 may provide, to the authorization server, a request for an access token, where the request includes the client identifier and the device code. For example, the request may include a polling request for an access token. When the authorization server has received the approval, the authorization server may provide, to computer system 112, the access token (such as a random or a pseudorandom number, an alphanumeric code, etc.). Note that the access token may have an associated expiration time, such as 1 day, 1 week, 1 month, etc.

Computer system 112 may receive, from the authorization server, the access token. Furthermore, computer system 112 may generate a CSR, and may provide, addressed to the CA (which may be included in computer system 130 or which may be separate from computer system 130), the CSR and the access token.

After receiving the CSR and the access token, the CA may check or confirm with the authorization server that the access token is valid (thus, the access token may be used as a challenge password for a certificate enrollment process). Additionally, the authorization server may provide, to the CA, the client identifier. Then, the CA may confirm that the client identifier matches corresponding information associated with the CSR. Moreover, the CA may provide, to computer system 112, a signed CSR that is the valid digital certificate for the client or the software. Computer system 112 may receive, from the CA, the signed CSR that is the valid digital certificate for the client or the software.

In these ways, the verification techniques may allow the valid digital certificate to be issued to an initially untrustworthy client or untrustworthy software. Notably, by leveraging the access token (e.g., from an OAuth 2.0 Device Authorization Grant), the validation techniques may allow a certificate enrollment protocol (such as SCEP) to be used without requiring a shared password in the CSR for validation by the CA or that an SCEP server issue digital certificates. Moreover, by eliminating the need for authorization server to subsequently verify all requests from the client, the validation techniques may remove a bottleneck during the verification. Consequently, the validation techniques may be scaled to a large number of users or clients in, e.g., a large-scale deployment or ecosystem. In some embodiments, the validation techniques may be automated (e.g., the administrator or the operator may not need to approve an authorization request associated with the client identifier). Therefore, the validation techniques may increase the satisfaction of users of the network, computer system 112 and/or computer system 130, such as operators or administrators and/or customers.

While the preceding discussion illustrated particular components performing operations in the verification techniques, in other embodiments different components may perform at least some of the operations. For example, operations performed by computer system 112 may be performed by computer system 130 (or vice versa). Alternatively or additionally, electronic device 110-2 may be included in computer system 112.

In some embodiments, the client is included in computer system 112 and the client may perform at least some of the operations performed by computer system 112. Alternatively, in some embodiments the client is separate from computer system 112. In these embodiments, computer system 112 may perform operations in the verification techniques to obtain the valid digital certificate for the client, and then may securely provide the valid digital certificate to the client. However, in other embodiments, the client performs at least some, if not all, of the operations performed by computer system 112 in the preceding discussion of the verification techniques. (Thus, in some embodiments, computer system 112 may obtain the valid digital certificate on behalf of another device, such as the client.)

More generally, in some embodiments, the verification techniques may, at least in part, be performed by different components, in a more centralized manner and/or a more distributed manner. Furthermore, components that perform operations in the verification techniques may be at an arbitrary location, e.g., local and/or remote from the network. For example, computer system 112 may be included in a machine room at a customer location. Alternatively, computer system 112 may be located in a field office or may be implemented in the cloud. Similarly, computer system 130 may be at an arbitrary location.

We now describe embodiments of the method. FIG. 2 presents a flow diagram illustrating an example of a method 200 for verifying a client in a network or software associated with the client, which may be performed by a computer system (such as computer system 112). During operation, the computer system may provide, addressed to an authorization server, a client identifier (operation 210) associated with the client or the software. Then, the computer system may receive, associated with the authorization server, information (operation 212), such as a device code, a user code and a verification location (such as a URI, a URL or a QR code). Moreover, the computer system may provide, addressed to the electronic device, at least some of the information (operation 214), such as the user code and the verification location. Next, the computer system may provide, addressed to the authorization server, a request for an access token (operation 216), where the request includes the client identifier and the device code, and the computer system may receive, associated with the authorization server, the access token (operation 218). For example, the request may include a polling request for the access token. Note that the access token may have an associated expiration time. Furthermore, the computer system may generate a CSR (operation 220), and may provide, addressed to the CA, the CSR and the access token (operation 222). Additionally, the computer system may receive, associated with the CA, a signed CSR (operation 224) that is a valid digital certificate for the client or the software.

Note that the electronic device may be an access point. In some embodiments, the client communicates (e.g., the client identifier) with the access point using wireless communication, and the access point may provide the client identifier to the computer system. For example, the wireless communication may be compatible with an IEEE 802.11 communication protocol. This wireless communication may allow the access point to selectively approve an authorization request at the verification location, which is associated with the client identifier. More generally, the client may, directly or indirectly, establish a trust relationship with the access point. For example, the client may be configured with a pre-shared key, may plug into a Universal Serial Bus (USB) in the access point, etc. Consequently, in some embodiments, the trust relationship may be establish using wireless communication (such as Wi-Fi, Bluetooth, etc.) or wired communication.

Moreover, in other embodiments, the client may include a second electronic device that an administrator or an operator uses to selectively approve the authorization request associated with the client identifier, which may be accessed using the verification location and the user code.

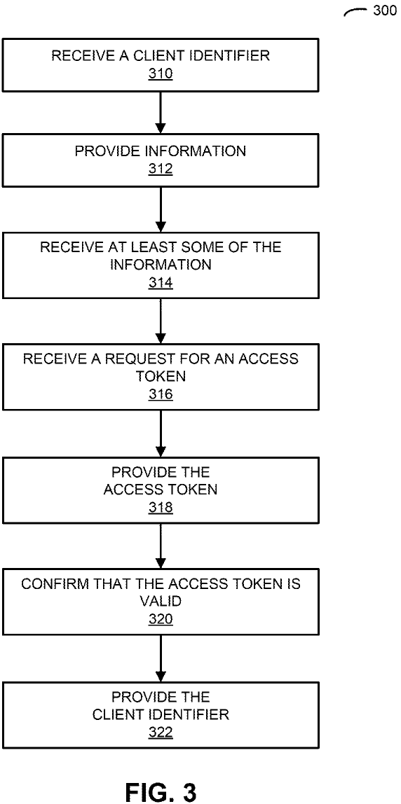

FIG. 3 presents a flow diagram illustrating an example of a method 300 for verifying the client in the network or software associated with the client, which may be performed by an authorization server (such as an authorization server in a second computer system, such as computer system 130). During operation, the authorization server may receive, associated with the computer system, the client identifier (operation 310). Then, the authorization server may provide, addressed to the computer system, information (operation 312), such as the device code, the user code and the verification location. Moreover, the authorization server may receive approval of the authorization request (operation 314) associated with the client identifier, where the approval is received from the administrator or the operator of the network or from the electronic device when the electronic device is an access point. Next, the authorization server may receive, associated with the computer system, the request for an access token (operation 316), where the request includes the client identifier and the device code. When the approval was received (operation 314), the authorization server may provide, addressed to the computer system, the access token (operation 318). Furthermore, the authorization server may confirm, for the CA, that the access token is valid (operation 320). Additionally, the authorization server may provide, addressed to the CA, the client identifier (operation 322).

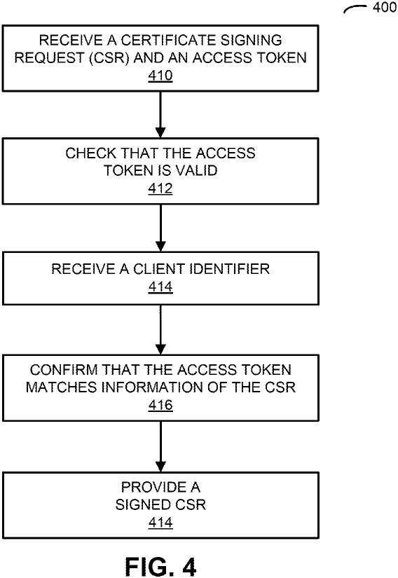

FIG. 4 presents a flow diagram illustrating an example of a method 400 for verifying the client in the network or software associated with the client, which may be performed by a CA (such as a CA in a second computer system, such as computer system 130). During operation, the CA may receive, associated with the computer system, the CSR and the access token (operation 410). Then, the CA may check, with the authorization server, that the access token is valid (operation 412). Moreover, the CA may receive, associated with the authorization server, the client identifier (operation 414). Next, the CA may confirm that the client identifier matches corresponding information associated with the CSR (operation 416). Next, the CA may provide, addressed to the computer system, the signed CSR (operation 418) that is the valid digital certificate for the client or the software.

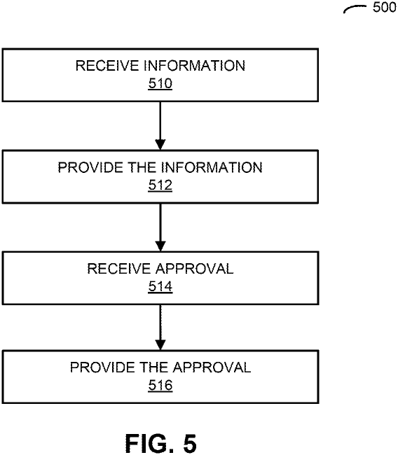

FIG. 5 presents a flow diagram illustrating an example of a method 500 for verifying a client in a network or software associated with the client, which may be performed by an electronic device (such as electronic device 110-2, access point 116-1 or radio node 118-1). During operation, the electronic device may receive, associated with the computer system information (operation 510), such as the user code and the verification location. Then, the electronic device may provide or present the information (operation 512), e.g., to the administrator or the operator. Moreover, the electronic device may receive a selective approval (operation 514) of the authorization request associated with the client identifier from the administrator or the operator of a network, and may provide, addressed to the authorization server, the approval (operation 516).

Alternatively, when the electronic device is an access point that previously had wireless communication with the client, the electronic device may: receive, associated with the computer system, the information (operation 510), such as the user code and the verification location; and provide, addressed to the authorization server, the approval (operation 516), where the approval may include the user code, the verification location and a certificate associated with the access point.

In some embodiments of method 200 (FIG. 2), 300 (FIG. 3), 400 (FIG. 4) and/or 500, there may be additional or fewer operations. Furthermore, the order of the operations may be changed, and/or two or more operations may be combined into a single operation.

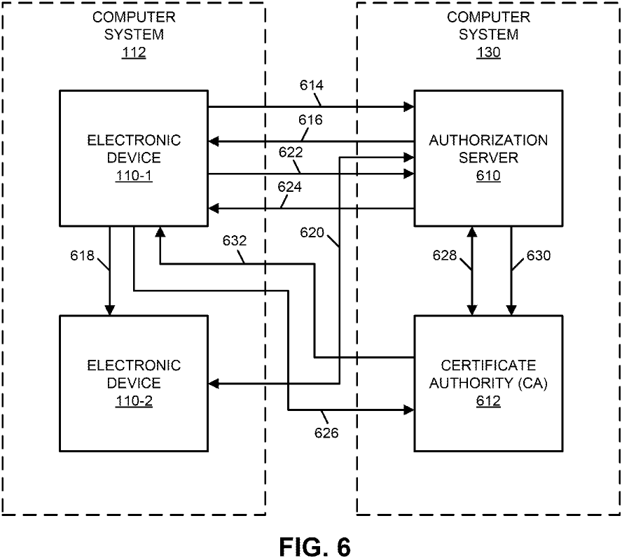

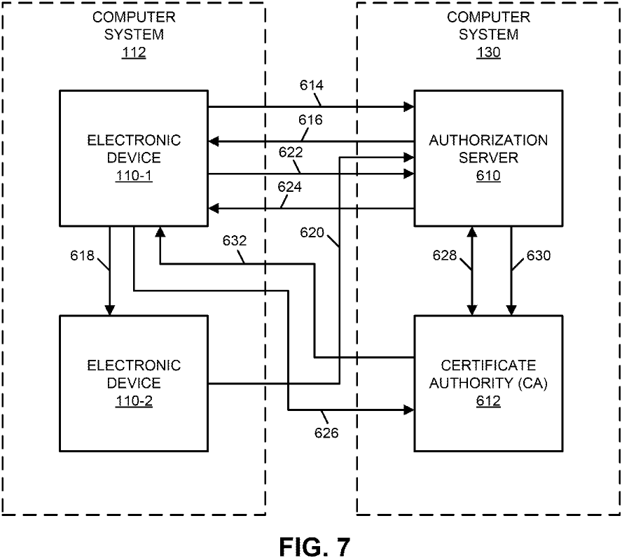

Embodiments of the verification techniques are further illustrated in FIGS. 6 and 7, which presents drawings illustrating an example of communication among components in FIG. 1. Notably, FIG. 6 presents a drawing illustrating an example of communication between computer system 112 (which includes electronic device 110-2 and a client of a network, such as electronic device 110-1), and computer system 130 (which includes an authorization server 610 and a CA 612).

During the verification techniques, electronic device 110-1 may send (operation 614) a client identifier to authorization server 610. In response, authorization server 610 may generate and provide (operation 616) to electronic device 110-1 a device code for electronic device 110-1, a user code (e.g., for an administrator or an operator of the network, or associated with account of the administrator or the operator) and a verification location (such as a URI, a URL or a QR code). Electronic device 110-1 may provide (operation 618) the user code and the verification location to electronic device 110-2. A user agent (such as a browser plugin or an application) on electronic device 110-2 may collect the user code and verification location for electronic device 110-1. Note that this information may be pushed to the user agent on electronic device 110-2 or may be pulled by the user agent from electronic device 110-2.

Then, the administrator or operator may login (operation 620) to authorization server 610 via the user agent using the user code and the verification location. In response, authorization server 610 may provide the client identifier (and/or associated information) to electronic device 110-2 for the administrator to review and to selectively approve (operation 620).

Moreover, electronic device 110-1 may request an access token (operation 622). In some embodiments, electronic device 110-1 may poll for the access token based at least in part on the device code and the client identifier. After authorization server 610 receives the approval from the administrator, authorization server 610 may generate and provide (operation 624) the access token with an expiration time to electronic device 110-1.

Furthermore, electronic device 110-1 may generate a CSR and may send (operation 626) the CSR to CA 612 with the access token. CA 612 may check (operation 628) that the access token is valid with the authorization server 610, and may obtain (operation 630) the client identifier from authorization server 610 and may check that the information in the CSR matches the client Identifier. Next, CA 612 may sign the CSR to be a valid digital certificate and may provide (operation 632) the valid digital certificate to electronic device 110-1.

FIG. 7 presents a drawing illustrating an example of communication among access point 116-1, computer system 112 (which includes access point 116-1 and a client of a network, such as electronic device 110-1), and computer system 130 (which includes authorization server 610 and CA 612).

During the verification techniques, electronic device 110-1 may send (operation 614) a client identifier to authorization server 610. In response, authorization server 610 may generate and provide (operation 616) to electronic device 110-1 a device code for electronic device 110-1, a user code (e.g., for an administrator or an operator of the network, or associated with account of the administrator or the operator) and a verification location (such as a URI, a URL or a QR code). Electronic device 110-1 may provide (operation 618) the user code and the verification location to access point 116-1.

While FIG. 6 illustrated administrator review and approval of the authorization request associated with the client identifier in order for electronic device 110-1 to receive an access token, FIG. 7 illustrates automated authorization. Notably, if there is a component in computer system 112 (and, more generally, in the network) that is trusted by authorization server 610, then the review and approval of the authorization request may be automatic. For example, access point 116-1 may replace the user agent. This access point may have a valid certificate (which is sometimes referred to as a ‘manufacturer certificate’) signed by the CA of the manufacturer of access point 116-1 when it was produced at a factory. Consequently, authorization server 610 may trust access point 116-1.

Moreover, electronic device 110-1 may connect to access point 116-1 with a shared secret or using another authentication technique. Because Wi-Fi has a distance limitation (or limited range), it may not be easy for a malicious party to compromise the authentication technique and the physical environment at the same time. Electronic device 110-1 may push (operation 618) the user code and the verification location to access point 116-1. Furthermore, access point 116-1 may trust electronic devices (such as electronic device 110-1) that can connect or associate with it. Thus, it may not be necessary to involve a human (such as the administrator) to review and selectively approve the authorization request. Access point 116-1 may send the user code and the verification location to authorization server 610 with its certificate, which may selectively approve (operation 620) the authorization request. As discussed further below, when the certificate of access point 116-1 is valid, authorization server 610 may issue the access token to electronic device 110-1.

Furthermore, electronic device 110-1 may request an access token (operation 622). In some embodiments, electronic device 110-1 may poll for the access token based at least in part on the device code and the client identifier. After authorization server 610 receives the approval from access point 116-1, authorization server 610 may generate and provide (operation 624) the access token having an expiration time to electronic device 110-1. (However, in other embodiments, the access token may not have an expiration time.)

Additionally, electronic device 110-1 may generate a CSR and may send (operation 626) the CSR to CA 612 with the access token. CA 612 may check (operation 628) that the access token is valid with the authorization server 610, and may obtain (operation 630) the client identifier from authorization server 610 and may check that the information in the CSR matches the client Identifier. Next, CA 612 may sign the CSR to be a valid digital certificate and may provide (operation 632) the valid digital certificate to electronic device 110-1.

While FIGS. 6 and 7 illustrate communication between components using unidirectional or bidirectional communication with lines having single arrows or double arrows, in general the communication in a given operation in this figure may involve unidirectional or bidirectional communication. Moreover, while FIGS. 6 and 7 illustrate operations being performed sequentially or at different times, in other embodiments at least some of these operations may, at least in part, be performed concurrently or in parallel.

Thus, the verification techniques may combine the benefits of a certificate enrollment protocol (such as SCEP) with an OAuth 2.0 Device Authorization Grant protocol and may reduce eliminate the drawbacks. Moreover, the verification techniques may allow digital certificates to be issued on a large scale. In some embodiments, the digital certificates may be issued using a fully automated process. In order to avoid a man-in-the-middle attack, in some embodiments a request for a certificate that is sent to the authorization server may be verified using a server certificate.

We now describe embodiments of an electronic device, which may perform at least some of the operations in the verification techniques. FIG. 8 presents a block diagram illustrating an example of an electronic device 800 in accordance with some embodiments, such as one of: base station 108, one of electronic devices 110, computer system 112, one of access points 116, one of radio nodes 118, switch 128 or computer system 130. This electronic device includes processing subsystem 810, memory subsystem 812, and networking subsystem 814. Processing subsystem 810 includes one or more devices configured to perform computational operations. For example, processing subsystem 810 can include one or more microprocessors, graphics processing units (GPUs), ASICs, microcontrollers, programmable-logic devices, and/or one or more digital signal processors (DSPs).

Memory subsystem 812 includes one or more devices for storing data and/or instructions for processing subsystem 810 and networking subsystem 814. For example, memory subsystem 812 can include DRAM, static random access memory (SRAM), and/or other types of memory. In some embodiments, instructions for processing subsystem 810 in memory subsystem 812 include: one or more program modules or sets of instructions (such as program instructions 822 or operating system 824, such as Linux, UNIX, Windows Server, or another customized and proprietary operating system), which may be executed by processing subsystem 810. Note that the one or more computer programs, program modules or instructions may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820 (or antenna elements). (While FIG. 8 includes one or more antennas 820, in some embodiments electronic device 800 includes one or more nodes, such as antenna nodes 808, e.g., a metal pad or a connector, which can be coupled to the one or more antennas 820, or nodes 806, which can be coupled to a wired or optical connection or link. Thus, electronic device 800 may or may not include the one or more antennas 820. Note that the one or more nodes 806 and/or antenna nodes 808 may constitute input(s) to and/or output(s) from electronic device 800.) For example, networking subsystem 814 can include a Bluetooth™ networking system, a cellular networking system (e.g., a 3G/4G/5G network such as UMTS, LTE, etc.), a USB networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 800 may be adapted or changed using pattern shapers (such as directors or reflectors) and/or one or more antennas 820 (or antenna elements), which can be independently and selectively electrically coupled to ground to steer the transmit antenna pattern in different directions. Thus, if one or more antennas 820 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 800 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices as described previously.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc.

Moreover, electronic device 800 may include a user-interface subsystem 830, such as: a mouse, a keyboard, a trackpad, a stylus, a voice-recognition interface, and/or another human-machine interface. In some embodiments, user-interface subsystem 830 may include or may interact with a touch-sensitive display in display subsystem 826.

Electronic device 800 can be (or can be included in) any electronic device with at least one network interface. For example, electronic device 800 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, and/or display subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments some or all of a given subsystem or component can be integrated into one or more of the other subsystems or component(s) in electronic device 800. For example, in some embodiments instructions 822 is included in operating system 824 and/or control logic 816 is included in interface circuit 818.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a communication circuit') may implement some or all of the functionality of networking subsystem 814 and/or of electronic device 800. The integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the verification techniques may be implemented using program instructions 822, operating system 824 (such as a driver for interface circuit 818) or in firmware in interface circuit 818. Alternatively or additionally, at least some of the operations in the verification techniques may be implemented in a physical layer, such as hardware in interface circuit 818.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device, an authorization server, and a certificate authority (CA), wherein the computer system is configured to:
provide, addressed to the authorization server, a client identifier associated with a client in a network or software associated with the client;
receive, associated with the authorization server, a device code associated with the client, a user code and a verification location;
provide, addressed to the electronic device, the user code and the verification location;
provide, addressed to the authorization server, a request for an access token, wherein the request comprises the client identifier and the device code;
receive, associated with the authorization server, the access token;
generate a certificate signing request (CSR);
provide, addressed to the CA, the CSR and the access token; and
receive, associated with the CA, a signed CSR that is a valid digital certificate for the client or the software.

2. The computer system of claim 1, wherein the verification location comprises a uniform resource identifier (URI), a uniform resource locator (URL) or an image that comprises the verification location.

3. The computer system of claim 1, wherein the request comprises a polling request for the access token.

4. The computer system of claim 1, wherein the access token has an associated expiration time.

5. The computer system of claim 1, wherein the electronic device comprises an access point in the network.

6. The computer system of claim 5, wherein the access point received the client identifier from the client via wireless communication, and provided the client identifier to the computer system.

7. The computer system of claim 6, wherein the wireless communication is compatible with an Institute of Electrical and Electronics Engineers (IEEE) 802.11 communication protocol.

8. The computer system of claim 1, wherein the client comprises a second electronic device and the computer system comprises the client.

9. The computer system of claim 1, wherein the user code is associated with an administrator or an operator of the network, or an account associated with the administrator or the operator.

10. A method for verifying a client in a network, comprising:
by a computer system:
providing, addressed to an authorization server, a client identifier associated with the client or software associated with the client;
receiving, associated with the authorization server, a device code associated with the client, a user code and a verification location;
providing, addressed to an electronic device, the user code and the verification location;
providing, addressed to the authorization server, a request for an access token, wherein the request comprises the client identifier and the device code;
receiving, associated with the authorization server, the access token;
generating a certificate signing request (CSR);
providing, addressed to a certificate authority (CA), the CSR and the access token; and
receiving, associated with the CA, a signed CSR that is a valid digital certificate for the client or the software.

11. The method of claim 10, wherein the electronic device comprises an access point in the network.

12. The method of claim 11, wherein the access point received the client identifier from the client using wireless communication, and the access point provided to client identifier to the computer system.

13. The method of claim 10, wherein the client comprises a second electronic device and the computer system comprises the client.

14. The method of claim 10, wherein the request comprises a polling request for the access token.

15. The method of claim 10, wherein the user code is associated with an administrator or an operator of the network, or an account associated with the administrator or the operator.

16. A computer system, comprising:
an interface circuit configured to communicate with an authorization server and a certificate authority (CA), wherein the computer system is configured to:
receive, associated with the authorization server, a client identifier associated with a client in a network or software associated with the client;
provide, addressed to the authorization server, a device code associated with the client, a user code and a verification location;
receive approval of an authorization request associated with the client identifier, wherein the approval is received from an administrator of the network or from an access point in the network;
receive, associated with the computer system, a request for an access token, wherein the request comprises the client identifier and the device code;
provide, addressed to the computer system, the access token;
confirm, for a certificate authority (CA), that the access token is valid; and
provide, addressed to the CA, the client identifier.

17. The computer system of claim 16, wherein the verification location comprises a uniform resource identifier (URI).

18. The computer system of claim 16, wherein the request comprises a polling request for the access token.

19. The computer system of claim 16, wherein the user code is associated with an administrator or an operator of the network, or an account associated with the administrator or the operator.

20. The computer system of claim 16, wherein the computer system comprises the authorization server and the CA.
